(19) United States
(12) Patent Application Publication
(10) Pub. No.: US 2011/0202624 A1
(43) Pub. Date: Aug. 18, 2011

(54) TECHNIQUES FOR SHARING CONTENT

(75) Inventor: Diane Najm, Kirkland, WA (US)

(73) Assignee: Virtual Gestures, LLC., Kirkland, WA (US)

(21) Appl. No.: 13/026,092

(22) Filed: Feb. 11, 2011

Related U.S. Application Data
(60) Provisional application No. 61/303,591, filed on Feb. 11, 2010.

(51) Int. Cl. G06F 15/16

(52) U.S. Cl. 709/207

(57) ABSTRACT

Techniques for receiving and organizing electronic greetings utilizing resources of an electronic social network. The different greetings may be exchanged between users to communicate a variety of different expressions. A sender may customize the greeting to include text for expressing sentiment that is appropriate for the receiver. Received greetings are organized in an electronic book representation that may include a list that ranks users that sent the most electronic greetings to a particular receiver, a list that summarizes received electronic greetings, and the actual electronic greetings on subsequent individual pages. Greetings or other techniques may be used to provide access to electronic scrapbooks. An interface provides users the ability to organize content in electronic scrapbooks. The electronic scrapbooks are designed for display in a manner designed at least in part by the users. Resources of the social network may be used to share the electronic scrapbooks with other users.

### CROSS REFERENCE TO RELATED APPLICATIONS

The present invention claims the benefit of priority under 35 U.S.C. §119(e) of U.S. Provisional Application No. 61/303,591 (Attorney Docket No. 028314-000100US), filed Feb. 11, 2010, the entire contents of which are incorporated herein by reference for all purposes.

### BACKGROUND OF THE INVENTION

A social network service focuses on building and reflecting of social networks or social relations among people, e.g., who share interests and/or activities. A social network service essentially consists of a representation of each user (often a profile), his/her social links, and a variety of additional services. Most social network services are web-based and provide means for users to interact over the Internet, such as e-mail and instant messaging.

The main types of social networking services are those which contain category places (such as former school-year or classmates), means to connect with friends (usually with self-description pages) and a recommendation system linked to trust. Popular methods now combine many of these, with Facebook, Bebo and Twitter widely used worldwide. Although some of the largest social networks were founded on the notion of digitizing real world connections, many other networks focus on categories from books and music to non-profit business to motherhood as ways to provide both services and community to individuals with shared interests.

### BRIEF SUMMARY OF THE INVENTION

Aspects of the present invention are directed to a method for sending, receiving and organizing electronic greetings used within the context of an electronic social network. The electronic greetings, in an embodiment, are exchanged between members of the same electronic social network who are linked together. The electronic greetings may be selectable from a gallery and may include a picture or an animation. The different greetings may be exchanged between users to communicate a variety of different expressions. Example greetings may express appreciation, friendship, congratulations, love, birthday wishes, sympathy, seasonal and holiday greetings, and the like. A sender may customize the greeting to include text for expressing sentiment that is appropriate for the receiver. All received greetings are organized in an electronic book representation that may include a list that ranks users that sent the most electronic greetings to a particular receiver, a list that summarizes received electronic greetings, and the actual electronic greetings on subsequent individual pages. An additional list may also be provided that includes a summary of sent electronic greetings. A group of specific electronic greetings may comprise a collection such that received greetings that are a part of the same collection may be displayed together in the same depiction of the collection. When the entire collection is received, the user may be awarded incentive points that may be redeemed to redeem rewards or purchase additional electronic greetings to send or add to a collection.

In one aspect of the invention, a method for receiving and organizing electronic greetings from users linked by an electronic social network includes receiving an electronic greeting from a user. The electronic greeting is sent from the user over an electronic social network (i.e., utilizing resources of an electronic social network provider). For example, the electronic greeting may be created and be made available to one or more recipients in a manner that utilizes computing resources of a social network service. A number of electronic greetings received from the user may be incremented. An entry of the received electronic greeting is provided in an electronic representation of a book of received electronic greetings. In the event that the received electronic greeting is part of a predetermined collection of received electronic greetings, the method additionally includes providing a representation of the received electronic greeting in a depiction of the collection and incrementing a number of incentive points associated with the collection.

In another aspect of the invention, users are provided the ability to create, view, and otherwise manage one or more electronic scrapbooks. An electronic scrapbook may be a collection of information configured to be provided for display such that, when viewed by a user using a display device, the electronic scrapbook appears similar to a physical scrapbook and is navigable in a manner similar to a physical scrapbook. For example, content of the electronic scrapbook may be organized according to one or more pages, such as a cover page and one or more interior pages. An interface may be provided to one or more users to allow the user to select, manipulate, arrange, and otherwise manage content for the electronic scrapbook. The electronic scrapbook may be stored in a manner that allows one or more users to view, edit, and/or otherwise access the electronic scrapbook using the Internet, a mobile communications network, and/or another communications network.

In an embodiment, the electronic scrapbook is managed using resources of a social network. For example, access to an application that allows viewing and/or editing of the electronic scrapbook may be available to users via an interface (such as a web site) of a social network provider. Content for the electronic scrapbook may be stored using storage resources of the social network provider. For instance, a user may utilize remote storage provided by the social network provider to store electronic images. The user may use such images to create the scrapbook. Access to the electronic scrapbook may be provided to users of the social network who share a common characteristic, such as users associated with accounts of the social network that are directly linked to an account of a creator of the electronic scrapbook. Access may be provided in various ways, such as using hyperlinks to the electronic scrapbook embedded in content of the social network, in electronic messages, or otherwise. One or more policies may be utilized to control access to the electronic scrapbook to ensure that only users that have been authorized to access the electronic scrapbook are granted access.

In one embodiment, a user who creates an electronic scrapbook is able to provide access to the electronic scrapbook to a set of users by sending electronic messages to members of the set. The electronic messages may be in various forms, such as electronic greeting cards sent to members of the set. The electronic greeting cards may include a hyperlink or other feature that provides recipients the ability to access the electronic scrapbook. In another embodiment, a user is able to post a notification to his or her account with a social network. A social network provider may notify a set of users of the posting to allow the members of the set to access the electronic scrapbook, if desired.

Various aspects of the present disclosure provide the ability for collaborative scrapbooking. A set of users of a social network, for example, may have the collective ability to create and/or modify an electronic scrapbook. A set of users having an account directly linked by the social network to a particular user, for example, may each be granted the ability to modify an electronic scrapbook. The users may each add their own content to the electronic scrapbook and may be able to view the scrapbook with content contributed by multiple users. Different users may also be provided the ability to take different actions. One or more users may, for example, be able to control an electronic scrapbook's layout and content arranged according to the layout while one or more other users may be provided to add limited content to and/or about the electronic scrapbook, such as by commenting on the electronic scrapbook's contents.

A further understanding of the nature and advantages of the present invention may be realized by reference to the remaining portions of the specification and the drawings.

### BRIEF DESCRIPTION OF THE DRAWINGS

FIG. 1 is a screenshot showing a gallery of selectable electronic greetings that may be sent to a user that is linked to a sender in the same electronic social network.

FIG. 2 is a screenshot showing a summary list of recently sent electronic greetings.

FIG. 3 is a screenshot showing a list of senders who sent an electronic greeting to particular linked users in the same social network.

FIG. 4 is a screenshot showing a list of the senders who sent the most electronic greetings to the receiver, and a front cover of an electronic book representation of the received electronic greetings.

FIG. 5 is a screenshot showing pages of the opened book representation that includes receiver information and a list that summarizes the received electronic greetings.

FIGS. 6-22 are screenshots showing the actual received electronic greetings that are included in the book representation.

FIGS. 23 and 24 are screenshots showing a collection of received electronic greetings that are associated with the same group.

FIG. 25 is a screenshot showing a balance of incentive points including an option to purchase additional incentive points.

FIG. 26 is a flowchart illustrating a method for receiving and organizing electronic greetings in accordance with embodiments of the present invention.

FIG. 27 is a screenshot showing an interface that enables a user to create electronic scrapbooks, in accordance with an embodiment.

FIG. 28 is a screenshot showing the interface of FIG. 27 in a state allowing the user to specify parameters for an electronic scrapbook.

FIG. 29 is a screenshot showing the interface of FIG. 27 in a state allowing the user to select an electronic scrapbook to view and/or edit.

FIG. 30 is a screenshot showing the interface of FIG. 27 in a state allowing the user to edit a cover of the electronic scrapbook.

FIG. 31 is a screenshot showing the interface of FIG. 27 in a state allowing the user to edit an interior page of the electronic scrapbook.

FIG. 32 is a screenshot showing the interface of FIG. 27 in a state after the user has added content to the interior page shown in FIG. 31.

FIG. 33 is a screenshot showing the interface of FIG. 27 in a state allowing the user to edit another interior page of the electronic scrapbook.

FIG. 34 is a screenshot showing the interface of FIG. 27 in a state allowing the user to provide access to one or more other users using an electronic communication.

FIG. 35 is a screenshot showing the interface of FIG. 27 in a state allowing the user to provide access to one or more other users using a feature of a social network.

FIG. 36 is a screenshot showing the interface of FIG. 27 in a state allowing the user to edit an interior page of the electronic scrapbook and to navigate to one or more other electronic scrapbooks.

FIG. 37 is a screenshot showing the interface of FIG. 27 in a state allowing a user to view the electronic scrapbook.

FIG. 38 is a flowchart illustrating a method for providing access to an electronic scrapbook.

FIG. 39 is a flowchart illustrating a method for controlling access to an electronic scrapbook.

FIG. 40 is a flowchart illustrating a method for generating an electronic scrapbook.

FIG. 41 illustrates a computer system that may be used in implementing one or more aspects of the present disclosure.

### DETAILED DESCRIPTION OF THE INVENTION

Aspects of the present disclosure are directed to a method for sending, receiving and organizing electronic greetings used within the context of an electronic social network. The electronic greetings are exchanged between members of the same electronic social network who are linked together. The electronic greetings are selectable from a gallery and may include a picture and an animation. The different greetings may be exchanged between users to communicate a variety of different expressions. Example greetings may express appreciation, friendship, congratulations, love, birthday wishes, sympathy, seasonal and holiday greetings, and the like. A sender may customize the greeting to include text for expressing sentiment that is appropriate for the receiver. All received greetings are organized in an electronic book representation that may include a list that ranks users that sent the most electronic greetings to a particular receiver, a list that summarizes received electronic greetings, and the actual electronic greetings on subsequent individual pages. An additional list may also be provided that includes a summary of sent electronic greetings. A group of specific electronic greetings may comprise a collection such that received greetings that are a part of the same collection may be displayed together in the same depiction of the collection. When the entire collection is received, the user may be awarded incentive points that may be redeemed to redeem rewards or purchase addition electronic greetings to send or add to a collection.

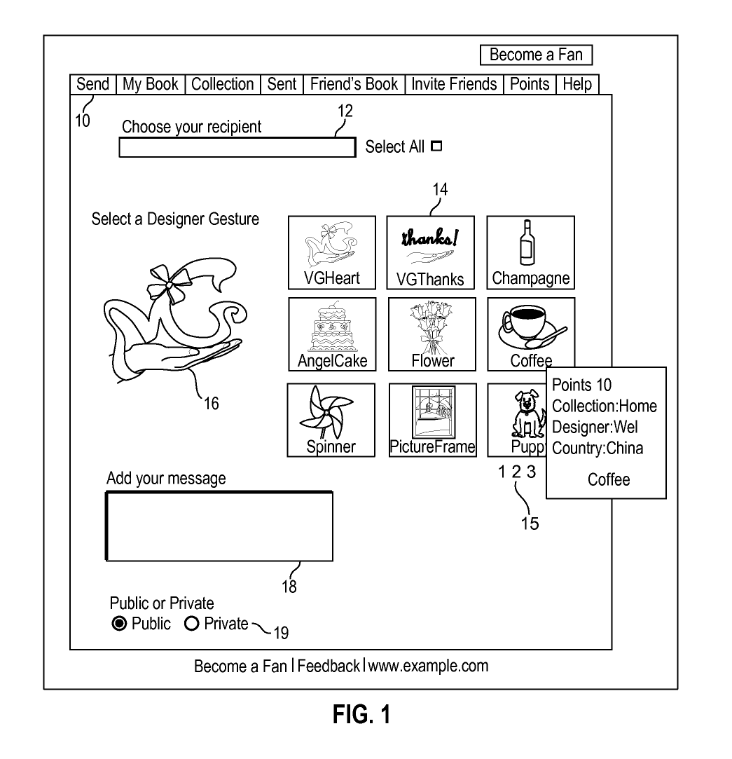

FIG. 1 is a screenshot showing a gallery of selectable electronic greetings that may be sent to a user that is linked to a sender in the same electronic social network. A send screen may be accessed by selecting a “send” option 10 from a toolbar. The send screen includes a recipient field 12 where a user can enter the name of one or more recipients of an electronic greeting. The send screen also includes a gallery of electronic greetings 14 that the user may select to send to the recipient. Although only nine electronic greetings are shown on the send screen, additional electronic greetings may be accessed by selecting different page representations 15. As shown in the figure, the user has selected the “VGHeart” electronic greeting. The selected electronic greeting appears in a preview panel 16 on the send screen. The user may also enter a customized message to include with the electronic greeting by entering text in a message field 18. In some embodiments, the user may select a public/private option 19 to make the electronic greeting viewable by only the recipient or by all users linked to the sender and the recipient.

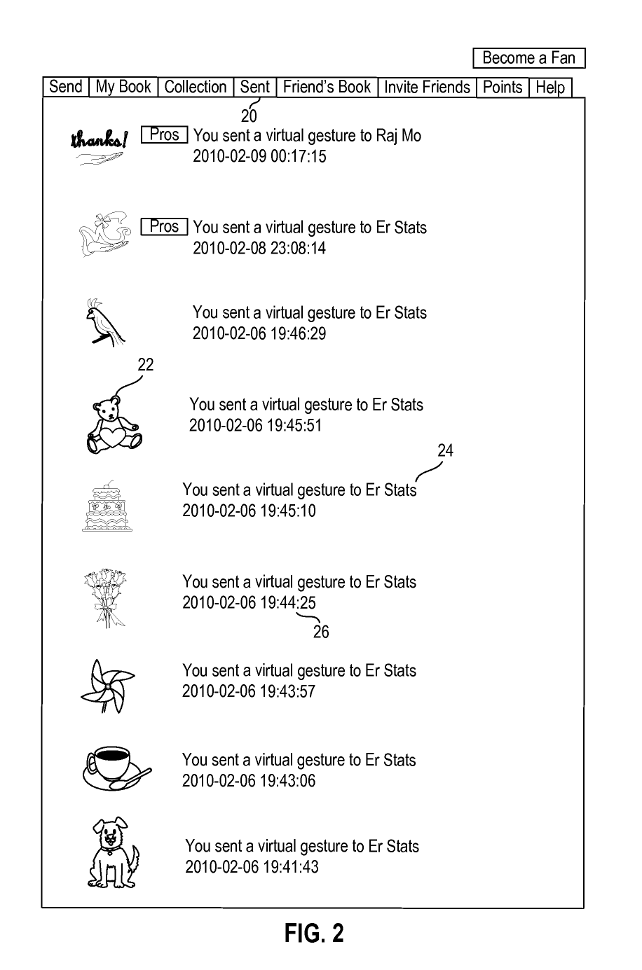

FIG. 2 is a screenshot showing a summary list of recently sent electronic greetings. The summary list may be accessed by selecting a “sent” option 20 from the toolbar. The summary list includes an entry for each electronic greeting sent by a user. Each entry may include a picture 22 that represents the electronic greeting, a name 24 of the recipient, and a time stamp 26 that indicates when the electronic greeting was sent.

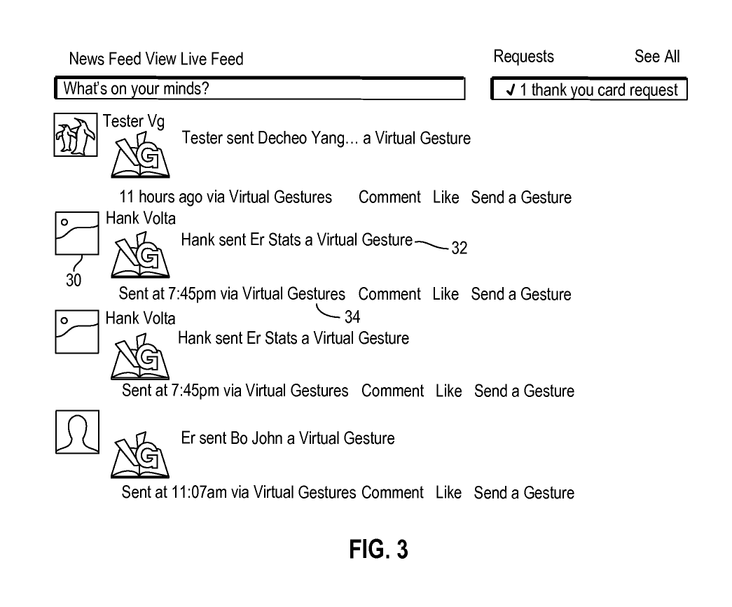

FIG. 3 is a screenshot showing a list of senders who sent an electronic greeting to particular linked users in the same social network. This electronic greeting activity screen may be accessed from a home page of the social network. Each entry on this screen may include a picture 30 that represents the sender of the electronic greeting, a statement 32 of the electronic greeting activity, and a timestamp 34 that indicates when the electronic greeting activity occurred.

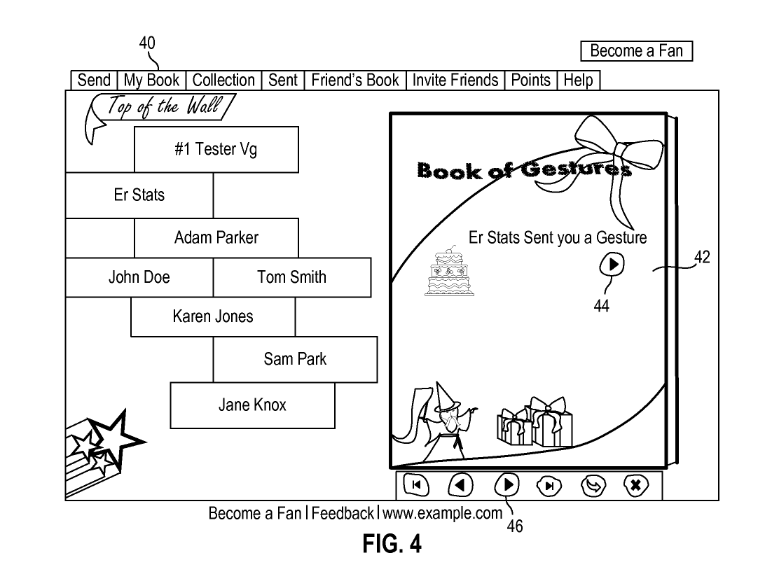

FIG. 4 is a screenshot showing a list of the senders who sent the most electronic greetings to the receiver, and a front cover of an electronic book representation of the received electronic greetings. This screen may be accessed by selecting a “my book” option 40 from the toolbar. The list of senders includes senders who sent the user an electronic greeting. As shown in the drawing, the sender named “Tester Vg” sent the user the most electronic greetings. Thus, this user's name appears at the top of the sender list (also referred to as “top of the wall”). If two or more users sent the same number of electronic greetings, these names may be displayed in the list side-by-side (e.g., John Doe and Tom Smith).

The electronic book representation 42 of the received electronic greetings includes an entry on the cover for any electronic greeting that has not yet been viewed by the recipient. The cover accordingly acts as a dynamic bulletin board for showing entries of the recently received electronic greetings. As shown in the drawing, the recipient has not yet viewed one electronic greeting. The user may select a “go-to” option 44 to open the book representation to the page where the new electronic greeting may be viewed. Pages of the book representation may also be accessed using a “turn page” option 46 or any of the other options listed on a lower portion of the screen below the book representation. In some embodiments, a user may customize the electronic book representation 42 to be displayed in accordance with personal preferences.

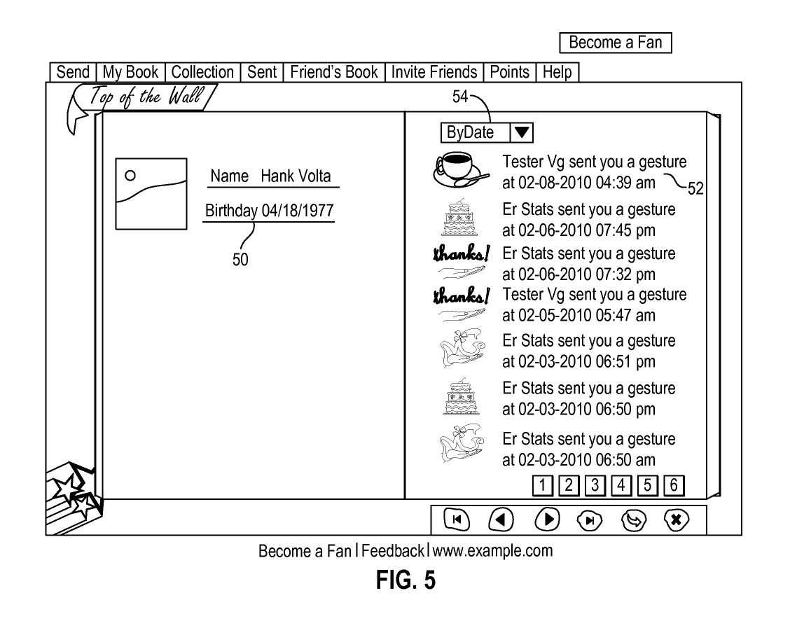

FIG. 5 is a screenshot showing pages of the opened book representation that includes receiver information and a list that summarizes the received electronic greetings. As shown in the drawing, the receiver information 50 is shown on one page, and the summary list 52 of received electronic greetings is shown on an opposite page. The user may select a display option 54 to change how entries in the summary list 52 are ranked. For example, the entries in the summary list may be ranked by date, by sender or by type of electronic greeting.

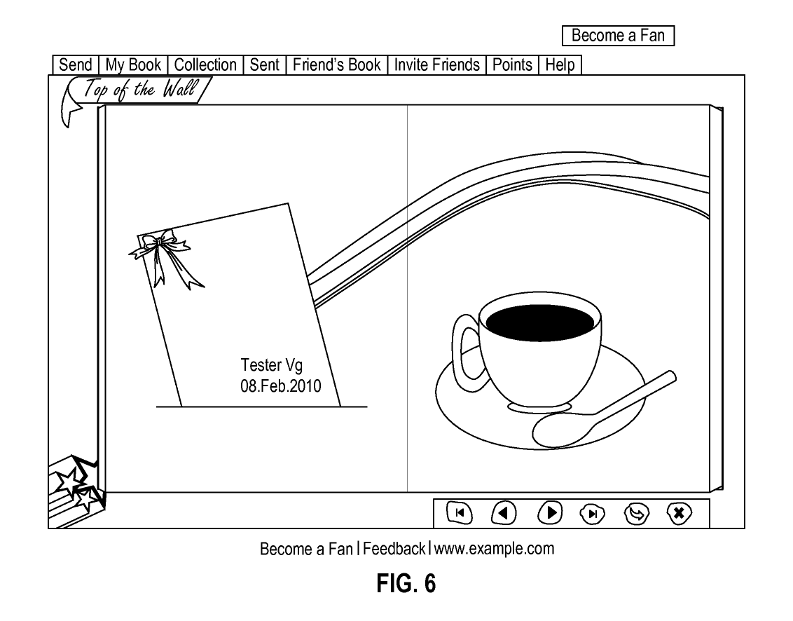

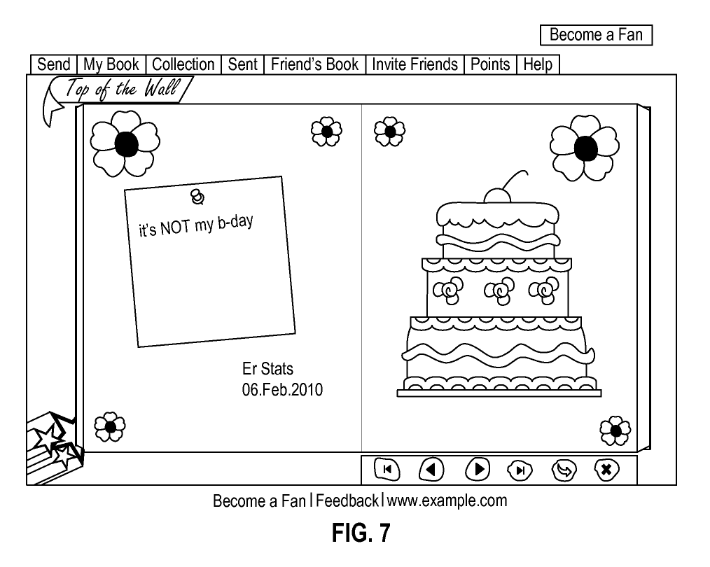

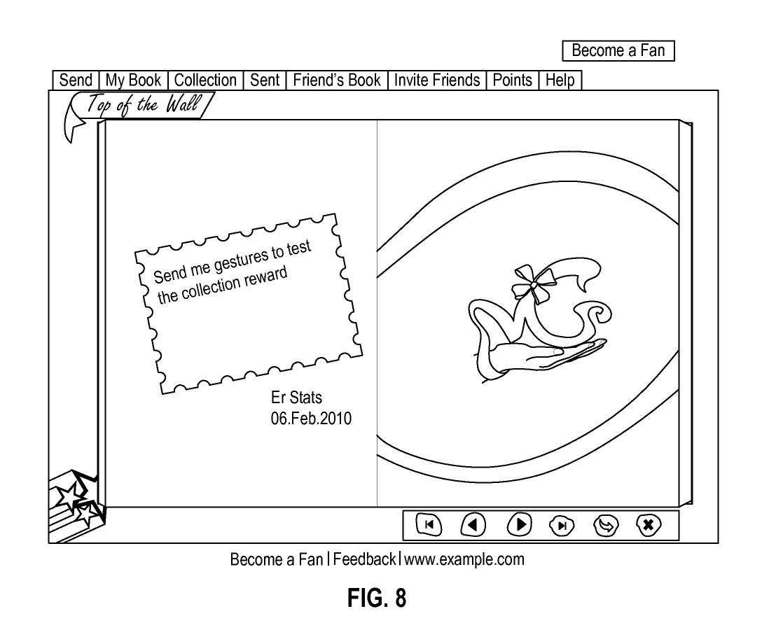

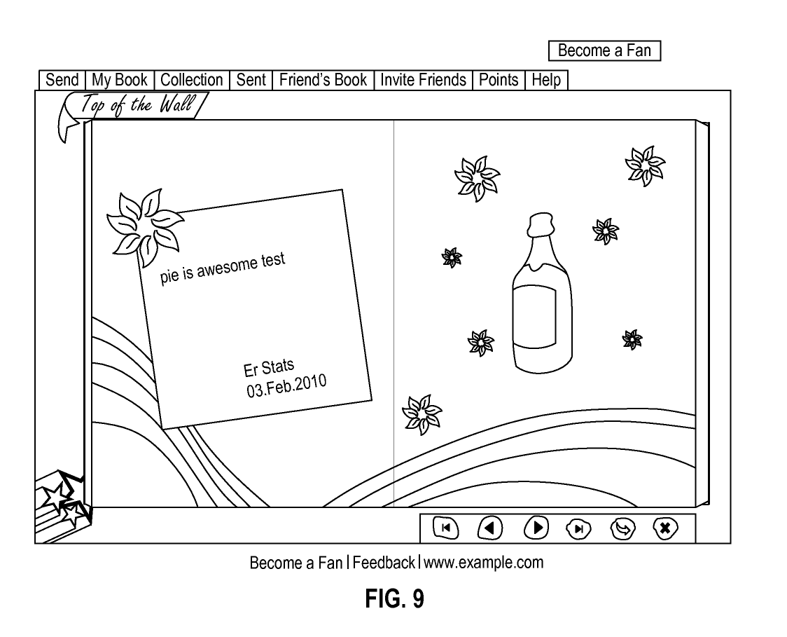

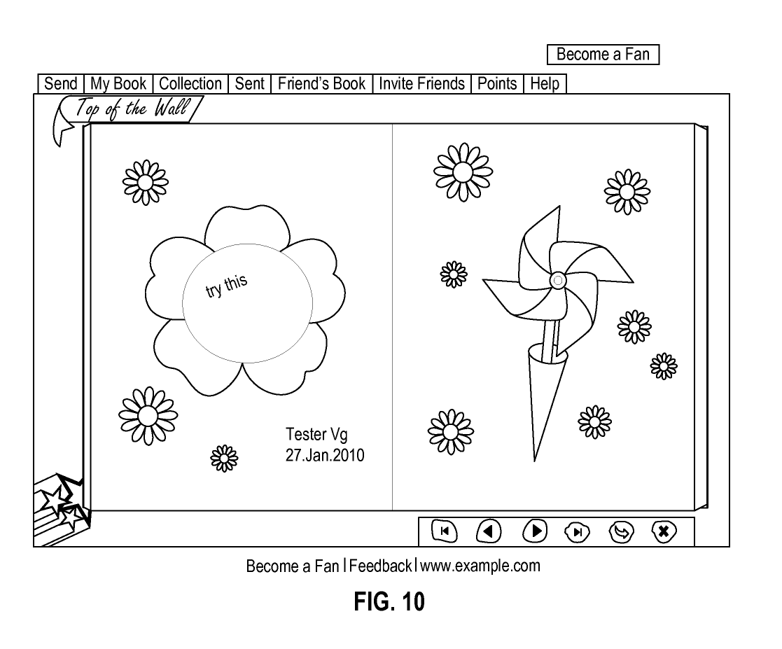

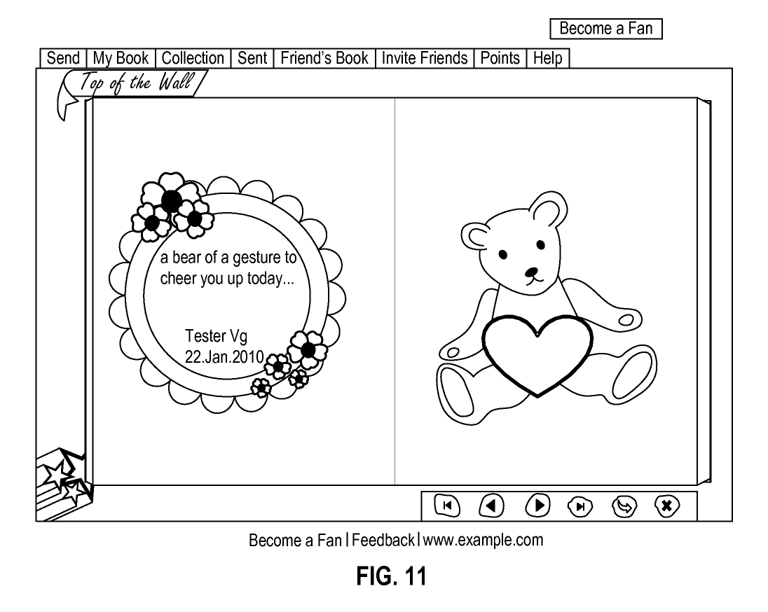

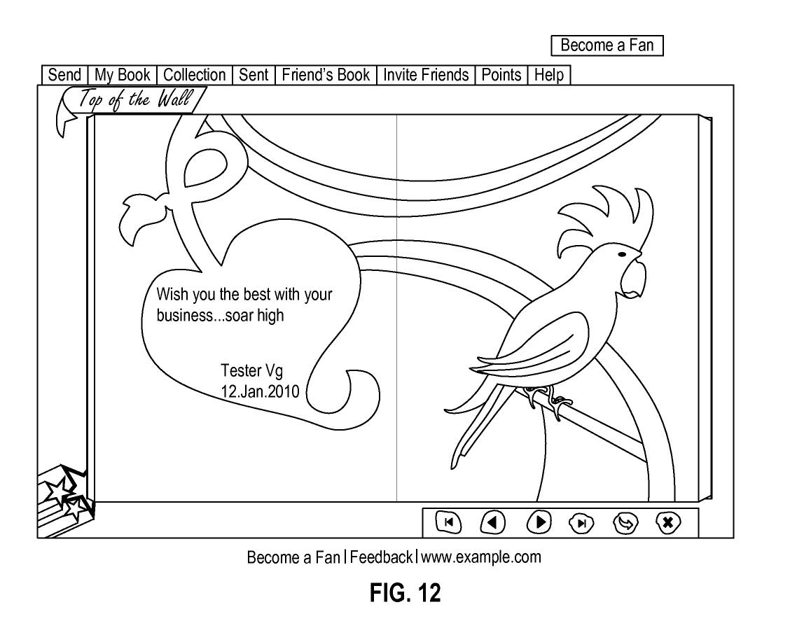

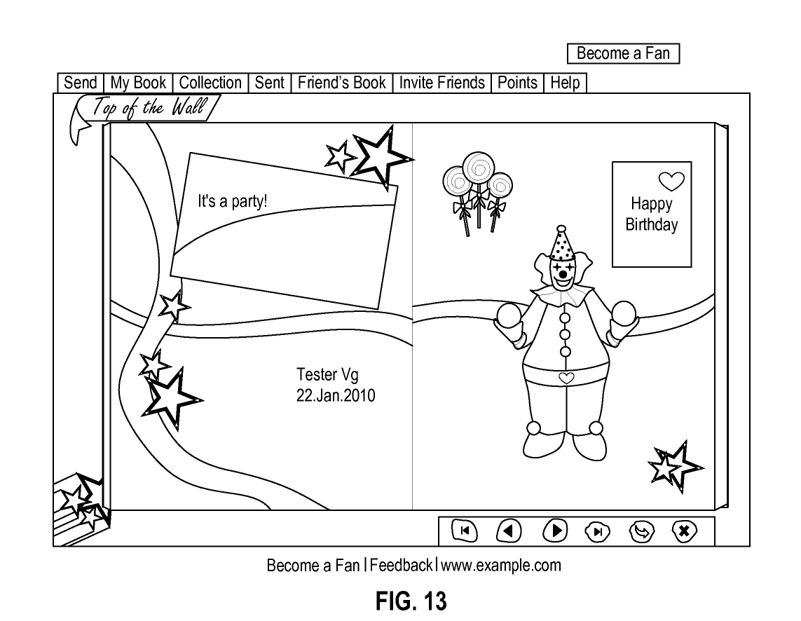

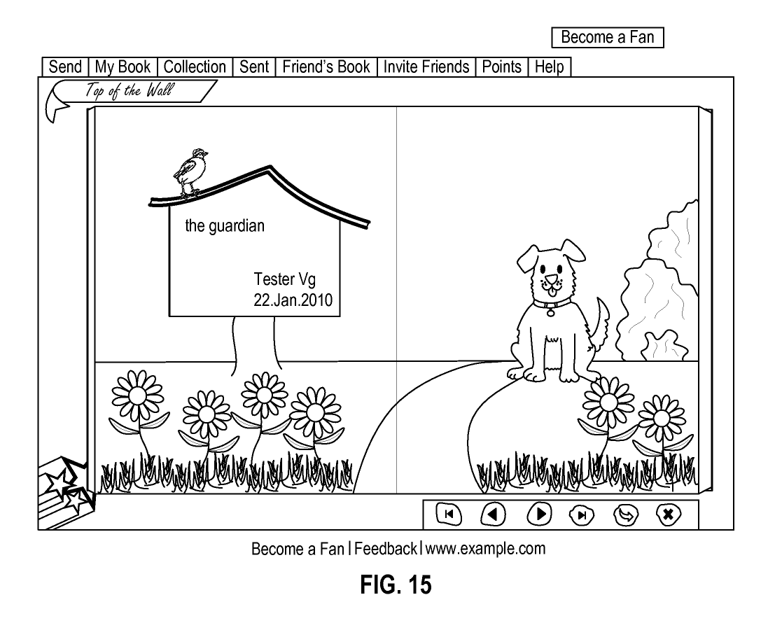

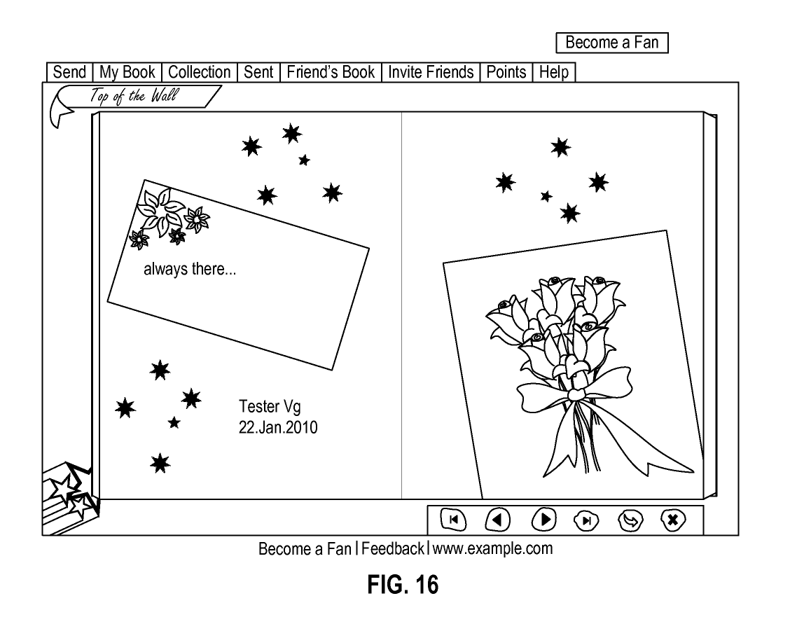

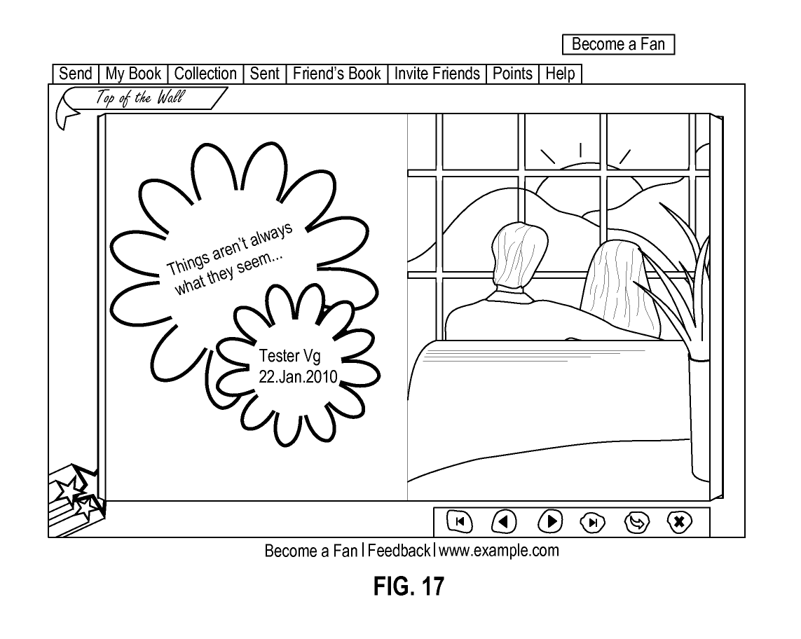

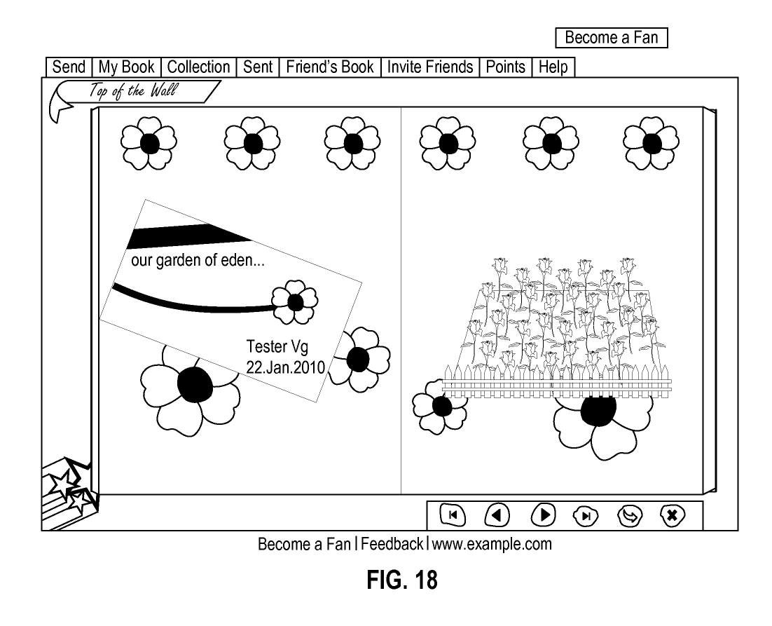

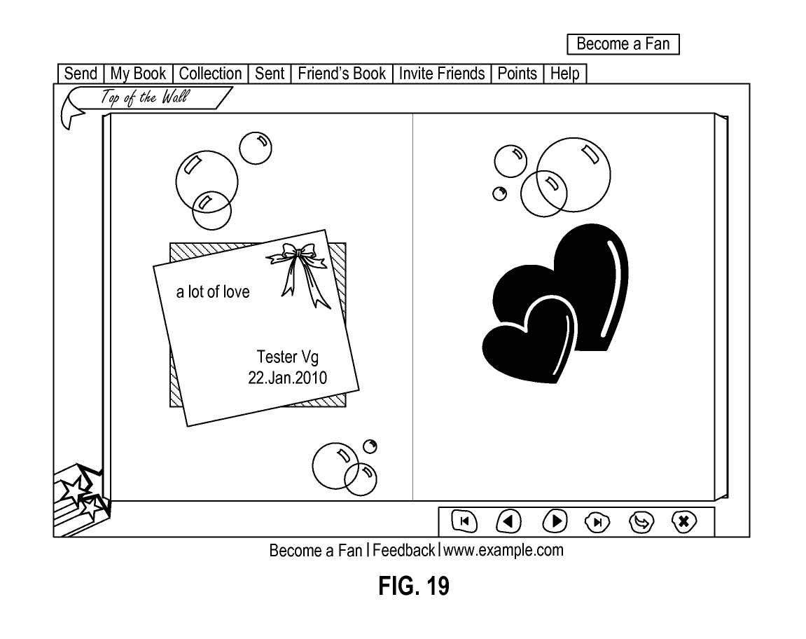

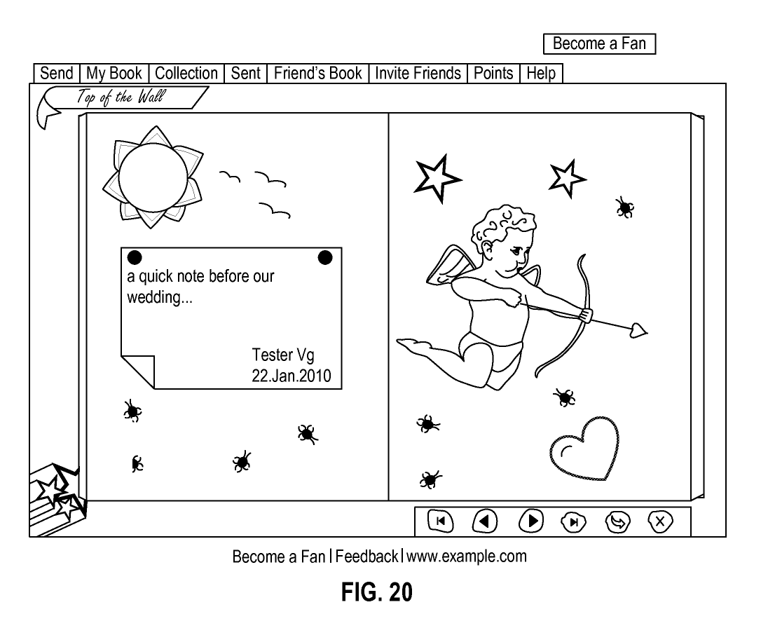

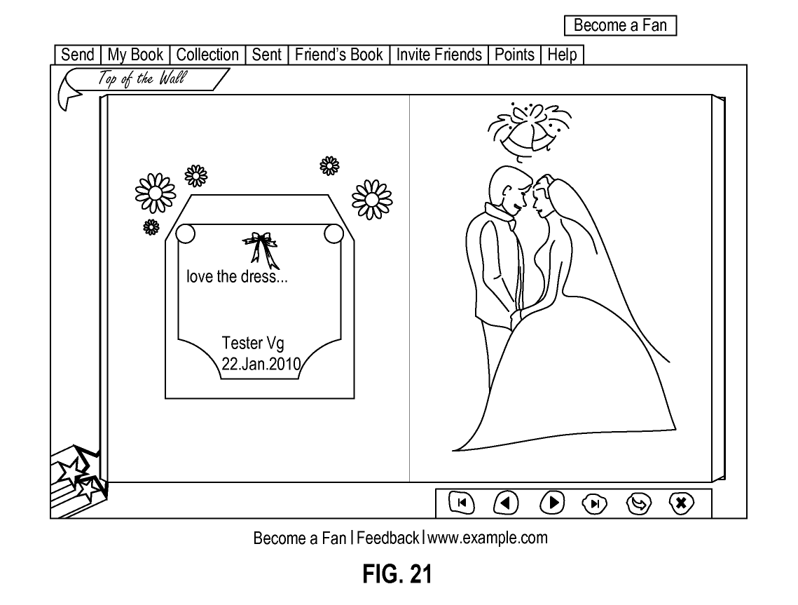

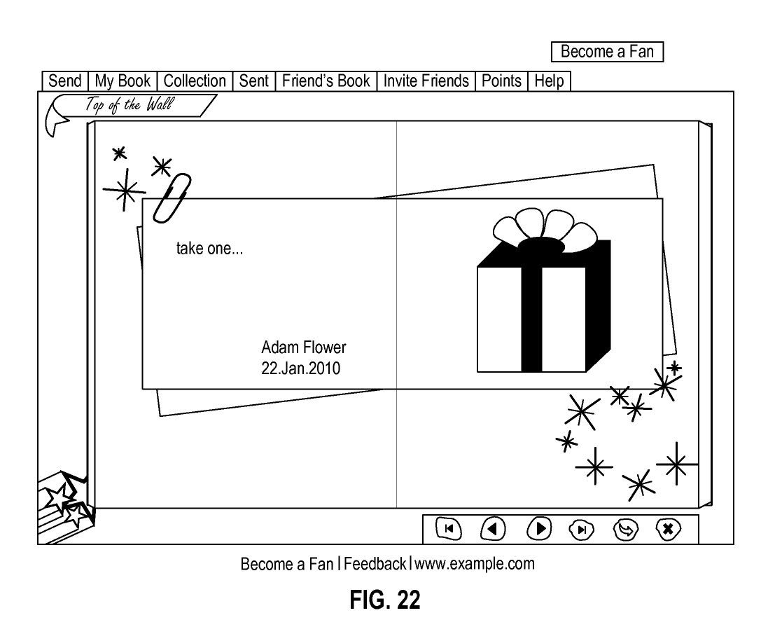

FIGS. 6-22 are screenshots showing the actual received electronic greetings that are included in the book representation. Each electronic greeting may include a picture, an animation, and a text panel that includes a message that was prepared by the sender. The electronic greeting may be selected to express appreciation, friendship, congratulations, love, birthday wishes, sympathy, seasonal and holiday greetings, and the like.

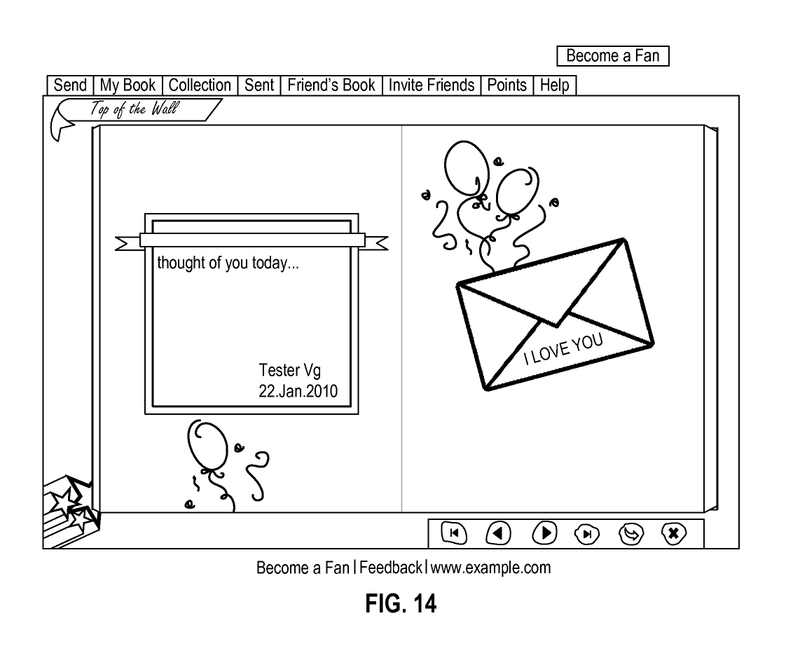

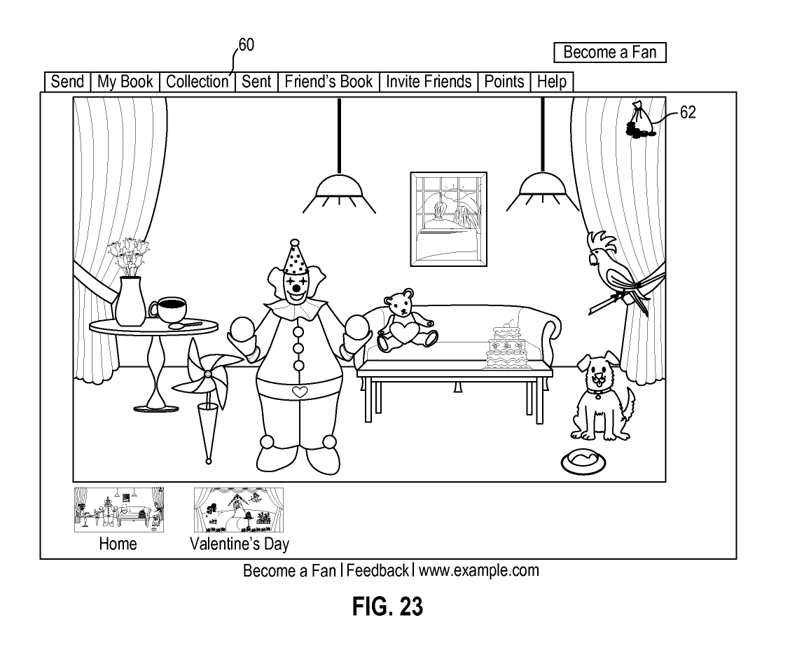

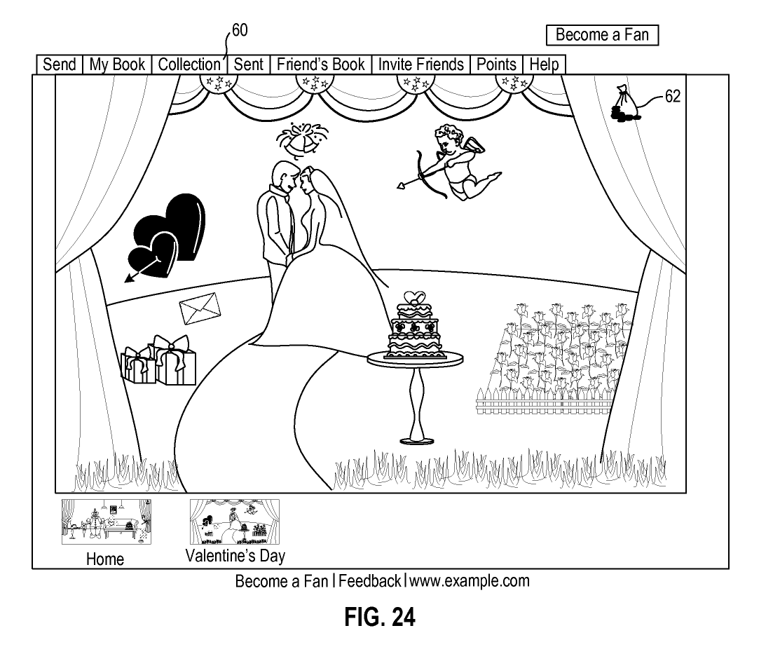

FIGS. 23 and 24 are screenshots showing a collection of received electronic greetings that are associated with the same group. This feature may be accessed by selecting a “collection” option 60 from the toolbar. Each collection is displayed in an on-screen depiction and includes a representation of each received electronic greeting. The depiction of the collection shown in FIG. 23 includes a representation of each electronic greeting in the “Home” group; namely, the depiction of the collection includes representations of the electronic greeting shown in FIGS. 6, 7, 10, 11, 12, 13, 15, 16 and 17. Similarly, the depiction of the collection shown in FIG. 24 includes a representation of each electronic greeting in the “Valentine Day” group; namely, the depiction of the collection includes representations of the electronic greetings shown in FIGS. 14, 18, 19, 20, 21 and 22. The number of electronic greetings in each collection displayed in the corresponding depiction increases as more electronic greetings associated with a particular group are received. As the number of received electronic greetings in each collection increases, the user is provided with incentive points as indicated by an incentive indicator 62 in an upper right portion of the screen.

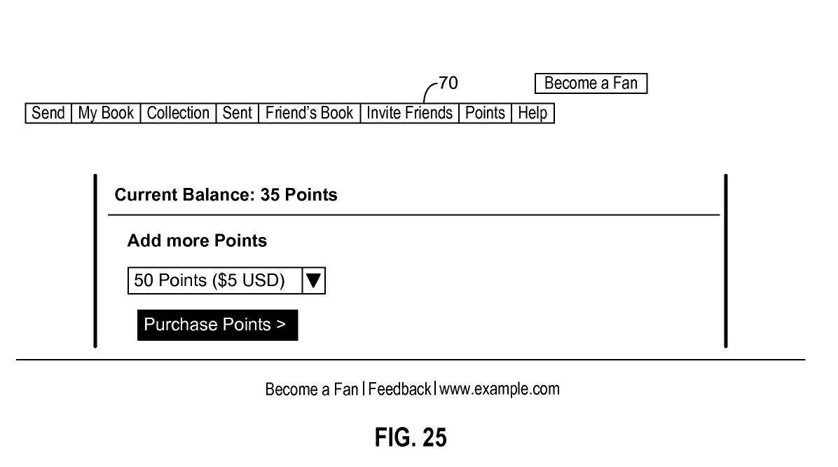

FIG. 25 is a screenshot showing a balance of incentive points including an option to purchase additional incentive points. The incentive points may be used to redeem awards or to purchase additional electronic greetings to send or to add to a collection. In some embodiments, the incentive points may be used to make a charitable donation. For example, an electronic greeting may be created that is associated with a charitable organization or cause. Users may access another user's electronic book representation by selecting a “friend's book” option 70 from a toolbar. The user may then access the electronic greeting associated with the charitable organization or cause from the friend's electronic book representation. The user may choose to copy the same electronic greeting to include in her own electronic book representation to show solidarity with or sympathy for the charity. In addition, the user may donate to the charity by making a direct donation or by surrendering incentive points.

FIG. 26 shows a flowchart for an illustrative example of a process for receiving and organizing electronic greetings in accordance with embodiments of the present invention. Some or all of the process illustrated in FIG. 26 (or any other processes described herein, or variations and/or combinations thereof) may be performed under the control of one or more computer systems configured with executable instructions and may be implemented as code (e.g., executable instructions, one or more computer programs, or one or more applications) executing collectively on one or more processors, by hardware, or combinations thereof. The code may be stored on a computer-readable storage medium, for example, in the form of a computer program comprising a plurality of instructions executable by one or more processors.

In an embodiment, the process includes receiving 100 an electronic greeting from a user who is linked to the recipient in the same electronic social network. The user selected the electronic greeting from a gallery and may have included a personalized message with the electronic greeting. The electronic greeting may include a picture and an animation that is used to communicate a particular expression. Example greetings may express appreciation, friendship, congratulations, love, birthday wishes, sympathy, seasonal and holiday greetings, and the like.

The number of electronic greetings received from the same user, in an embodiment, is incremented 110 by one. The tally of electronic greetings received from particular users may be used to identify which users send the most electronic greeting to the receiver. The senders may then be ranked in a list according to which users sent the most electronic greetings.

An entry representing the received electronic greeting, in an embodiment, is included 120 in a representation of a book of received electronic greetings. One entry may be provided on a full page or two opposing pages of the book representation to illustrate the full electronic greeting including any picture, animation and text. Another entry may be provided on a cover of the representation of the book to indicate that the electronic greeting is newly received and has not yet been viewed by the receiver. Still another entry may be provided on a page of the book representation that lists recently received electronic greetings.

In an embodiment, a determination is made 130 whether the received electronic greeting is part of a predetermined collection of electronic greetings. Each collection may include a group of electronic greetings that are associated with each other. For example, a collection may include a group of electronic greetings that are associated with the same holiday or event. If the received electronic greeting is not part of a collection, processing terminates. If the received electronic greeting is part of a collection, processing continues to step 140.

A representation of the received electronic greeting, in an embodiment, is provided 140 in a depiction of the collection of which the electronic greeting is a part. For example, a picture from each received electronic greeting that is associated with the same collection is displayed in the same depiction of the collection such that a user may be able to identify easily which additional electronic greetings are required to complete the collection. A number of incentive points may be then incremented 150 by one to indicate that the user received an electronic greeting that is part of a predetermined collection. The incentive points may be used to redeem rewards or to purchase additional electronic greetings to send to other users or to add to an collection. Processing then terminates.

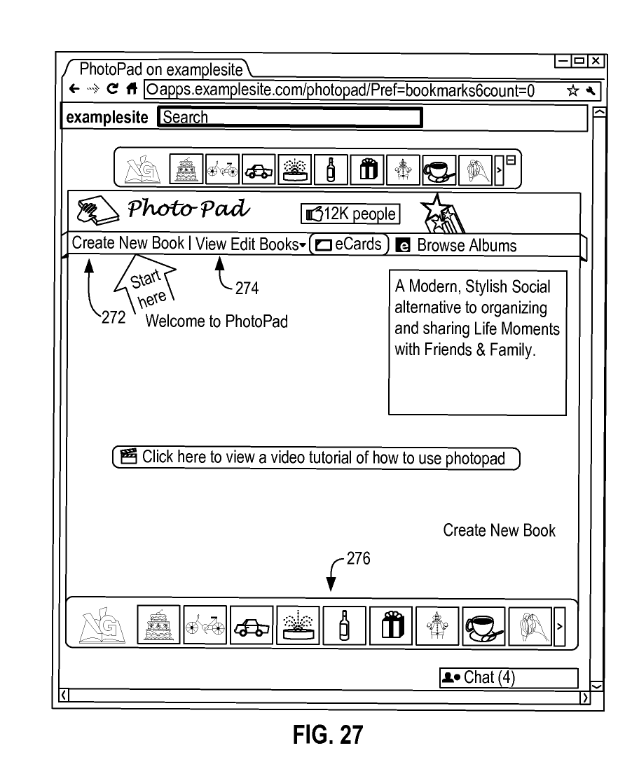

Various embodiments of the present invention also are directed to the management of virtual collections of images and other content in a social networking environment. In an embodiment, resources of a social network are used to provide users an intuitive interface for creating, editing, viewing, and/or sharing image collections. The interface, in one embodiment, may be implemented as a component of another interface, such as a web site of an electronic social network provider. The image collections may be presented to one or more users in the form of a virtual scrapbook, as described in more detail below. The images may include, for example, electronic photographs that one or more users have uploaded or otherwise provided to one or more servers of an operator of a social network. The images may correspond to gestures, such as gestures described above. The images may, generally, include other types of content, such as content in audio, video, text, interactive content, and/or other types of content. FIGS. 27-37 are screenshots of illustrative embodiments of such an interface. FIG. 27, for example, is a screenshot of an application that may be used to manage image collections. In this illustrative example, the screenshot of FIG. 27 shows a graphical user interface (GUI) that includes various interface elements for the performance of corresponding functions. Some or all of the functions may be involved in the management of electronic scrapbooks. As with various interface elements described above, users may interact with the various interface elements using an appropriate input device, such as a mouse, a keyboard, a touchpad, a touch screen, and/or other input device.

As an example, the screenshot of FIG. 27 includes an electronic scrapbook creation button 272 and an electronic scrapbook viewing/editing button 274. A user may select the electronic scrapbook creation button 272 to begin a process of creating an electronic scrapbook. A user may select the electronic scrapbook viewing/editing button 274 to view and/or edit one or more previously-created electronic scrapbooks. Other features may be included on the interface, such as features related to managing gestures, such as described above. As illustrated in FIG. 27, the interface may include a gesture toolbar 276 that includes a plurality of images, each image corresponding to a type of gesture and being selectable for beginning a process for sending a corresponding type of gesture.

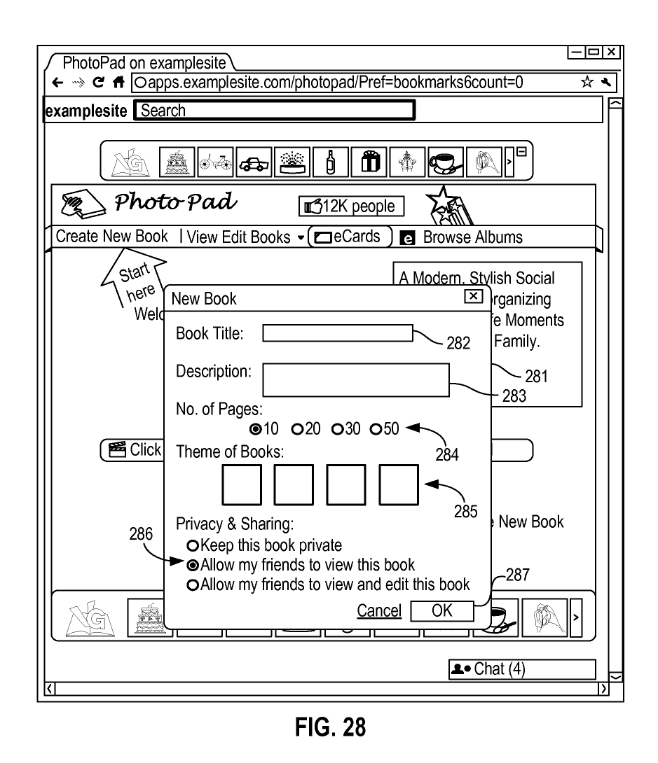

FIG. 28 shows a screenshot of the interface of FIG. 27 after selection of the electronic scrapbook creation button 272. In this illustrative embodiment, the screenshot of FIG. 28 includes a pop-up box 281 containing fields for user entry of information relating to a new electronic scrapbook. For instance, in this example, a book title field 282 allows for textual input of a title for an electronic scrapbook. A description field 283 allows for textual input of a description of contents of the electronic scrapbook. A user may, for instance, use the description field to specify that the corresponding electronic scrapbook contains photographs from a particular family vacation. A page number series of radio buttons 284 allows a user to select a number of pages for the corresponding electronic scrapbook. A user may, for example, anticipate needing approximately ten pages and, therefore, select a radio button labeled as “10.” If the user eventually needs more or fewer pages, he or she may use the interface to add or delete pages. In this manner, a user may receive a number of pages to edit that is approximate to a number of pages that is anticipated, thereby avoiding requiring the user to repeatedly use the interface to add additional pages.

A theme series of images 285 may also be included to allow a user to select a theme for the corresponding electronic scrapbook. A theme may be a predetermined set of specifications for electronic scrapbooks. The specifications may include, for example, specifications for background images, specifications for interface elements for allowing users to insert images or other content in predetermined locations, specifications for images (such as images relating to a holiday related to a theme) to be included in predetermined locations in the electronic scrap book, predetermined elements into which users may enter text and other content, predetermined layouts for the pages, and the like. Generally, the theme may include specifications for providing a partially-completed electronic scrapbook that users may use as a basis for creating their own electronic scrapbook. A user may, in an embodiment, delete or modify predetermined elements of an electronic scrapbook, as shown in more detail below. Additionally, in an embodiment, a user may add elements to those provided as a result of selection of a theme. In the illustrative example shown in FIG. 28, a plurality of themes are provided to the user for selection in the form of selectable images.

A series of privacy radio buttons 286 may allow a user to select a plurality of privacy settings for the corresponding electronic scrapbook. In this particular example, the user may select from “Allow my friends to view this book” and “allow my friends to view and edit the book.” By selecting the first option, friends (i.e. users having accounts that are directly linked to the user's account by a social network) may view the electronic scrapbook that the user creates. By selecting the second option, friends are not only able to view the electronic scrapbook, but are able to edit the electronic scrapbook as well. Other users may be, for example, allowed to add additional pages to the scrapbook and content for the added pages. Friends may be provided the ability to comment on pages of the scrapbook or otherwise add content to or change the electronic scrapbook. In this manner, the electronic scrapbook may be a collaborative project. Further, friends may be allowed limited privileges. For instance, friends of a user who initiated an electronic scrapbook may be allowed to add content, but may be prohibited from deleting or changing existing content, or may delete or change existing content subject to approval of the user. Generally, the user may maintain administrative control over the content of the electronic scrapbook.

Once the user has specified information for an electronic scrapbook using the drop down box 281, the user may select a submission button 287 and information specified by the user is provided to an operator of the interface over a communications network, such as the Internet. Other ways of providing information may also be used. For instance, while FIG. 28 shows a static drop down box 281, information may be provided dynamically and appropriate fields may appear dynamically using various techniques, such as asynchronous JavaScript and XML (AJAX) programming.

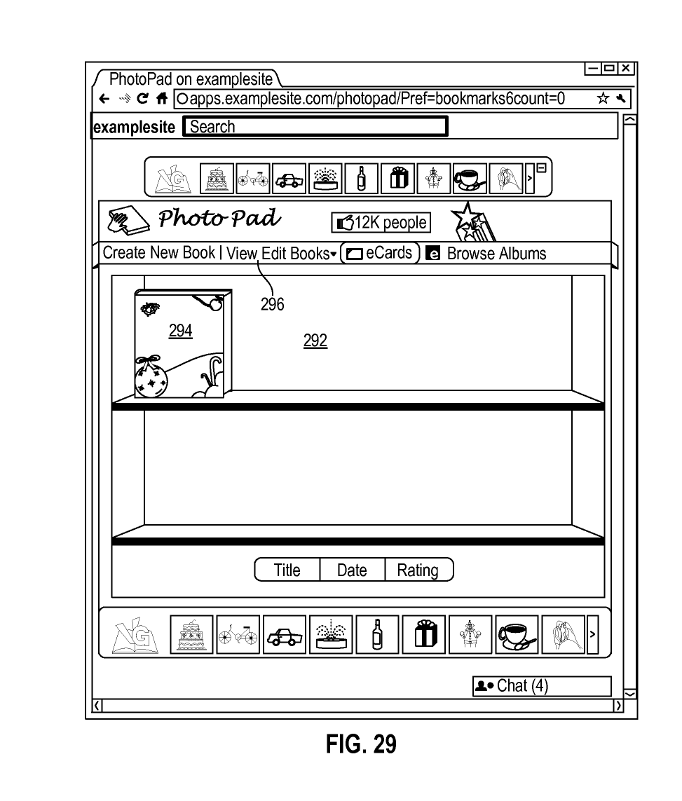

FIG. 29 shows an illustrative example of a screenshot of the interface that may result from user selection of the submission button 287 of FIG. 28. For example, a browser of the user may, upon selection of the submission button 287, send an electronic message over a communications network to a server that is operable to receive the message. The server or another device of a system of which the server is a part may utilize information in the electronic message (which, in an embodiment, is information specified in the various fields in the screenshot of FIG. 28) to create an electronic record for an electronic scrapbook. An application may, for example, cause a record in a database to be created for the electronic scrapbook. The same or another application then may render an interface page such as the screenshot illustrated in FIG. 29.

In this particular example, the interface page includes a virtual bookshelf 292 on which images representing electronic scrapbooks available to the user may be displayed. For instance, in this example, a representation of an electronic scrapbook 294 appears on a top shelf of the virtual bookshelf 292. In this embodiment, the representation of the electronic scrapbook 294 corresponds to the electronic scrapbook created by the user by selecting the submission button 287. While not shown in this example, other representations of other electronic scrapbooks may appear on the virtual bookshelf 292. For instance, if the user has created other electronic scrapbooks in the past, representations of those electronic scrapbooks may appear on the virtual bookshelf 292. Electronic scrapbooks created by other users as well as electronic scrapbooks created collaboratively by the user and other users may appear on the virtual bookshelf 292. In an embodiment, the contents of the virtual bookshelf 292 are managed for the user. The user may also be given control over the contents of the virtual bookshelf 292. For instance, the user may be allowed to control which electronic scrapbooks appear on the virtual bookshelf 292, the order of electronic scrapbooks on the virtual bookshelf 292, and may be given control of other aspects of the virtual bookshelf and/or its contents.

In an embodiment, the user is able to select an electronic scrapbook from the virtual bookshelf 292 to view and/or edit its contents. The user may, for instance, select the representation of the electronic scrapbook itself. Once selected, selectable text elements of “view” and “edit” may appear for the user to select to begin to view or edit the electronic scrapbook. Similarly, the user may select a view/edit button 296 to view and/or edit a selected representation of an electronic scrapbook.

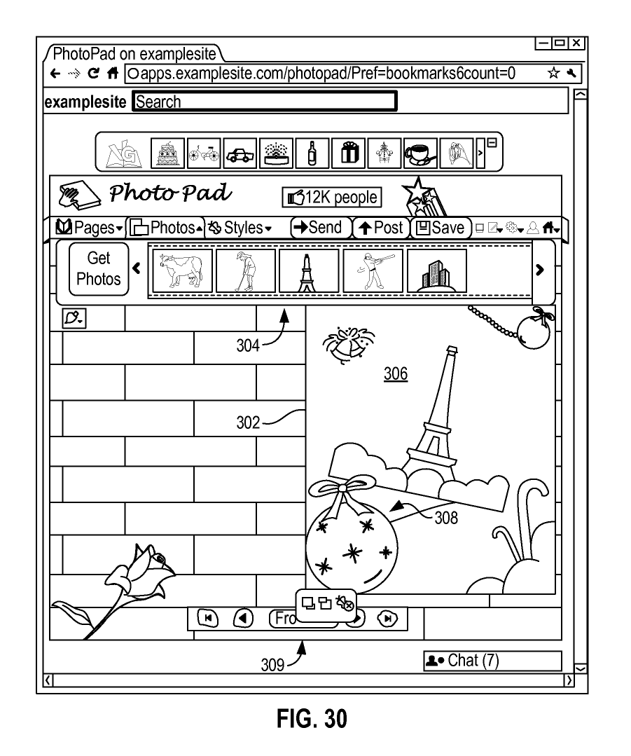

FIG. 30 shows a screenshot of the interface that may be presented to the user upon selection of the view/edit button 296 of FIG. 29. In this example, a cover 302 of the electronic scrapbook is presented to the user. In addition, in the illustrated embodiment, a picture bar 304 is provided to the user to allow the user to select from a set of images available to the user. The images may be, for example, images uploaded by the user to a social network account of the user. The images may be stored remotely from the user using storage resources of a provider of a social network. Images may be made available to the user in other ways. For instance, in one embodiment, users of the social network are able to tag images with identifiers of users of the social network. If an image is a photograph of a group of users of the social network, one or more users may cause computing resources of the social network to associate the image with one or more of the users. A user may specify the members of the set of users in the photograph, as an example. Thus, in this embodiment, the user of the interface shown in FIG. 30 may have available images that have been tagged with the user. Other ways of making sets of images available to the user may also be used.

In an embodiment, the user is allowed, through the interface, to manipulate the contents of the cover 302. For example, as shown in FIG. 30, the cover 302 includes a photograph 306 that the user added to the cover 302. The user may have, for example, used a drag-and-drop input operation to select the image from the picture bar 204 to cause the image to appear on the cover 302. Prior to selecting the image, the cover 302 may include an outline of an area of the cover 302 to be used for display of the image 302. The user may be provided one or more interface controls to manipulate the outline and/or image on the cover 302. The user may, for example, resize, move, rotate, or otherwise perform operations for changing the visual appearance.

Other elements may be included for users to design electronic scrapbooks. For instance, as shown in FIG. 30, the interface includes various ornamentations, which may be images relating to a theme of the electronic scrapbook. A bulb ornament 308, for instance, is included in the illustrated example. A frame around the bulb ornament 308 includes controls for manipulation of the appearance of the bulb ornament, such as with the photograph 306. Other ornamentations illustrated include images of bells, other bulbs, candy canes, and images of other objects. Users may change, rearrange, add, delete, or otherwise configure the appearance of the various ornamentations in order to customize their electronic scrapbook.

In an embodiment, the interface provides to the user various navigational controls. For example, a navigation bar 309 appears at the bottom of the display in FIG. 30. The navigation bar 309, in an embodiment, includes various navigational controls for navigating through the various pages of the electronic scrapbook. Thus, for example, a user wishing to view and/or edit a page of the electronic scrapbook other than the cover 302 may select a button of the navigation bar 309 to navigate to another page of the electronic scrapbook. Selection of a button with a right arrowhead on the button, in this example, allows the user to navigate to the next page of the electronic scrapbook. Selection of a navigational control may cause an electronic message to be sent to a server that, in turn, sends information to the user to allow a device of the user to display the page to which the user navigated. FIG. 31, for example, shows a screenshot of an interface page displayed to the user that has navigated from the cover 302 to the next page. In order to maintain a visual resemblance of an actual book, the page shown in FIG. 31 has the appearance of two pages of an open (physical) book, although the page may have other appearances.

In this particular example, the user has not designed the page to which the user has navigated. Accordingly, various template elements are displayed to the user to guide the user in designing the pages and to provide at least some of the design as already completed. In this example, for instance, various image holder elements 312 are provided to the user in predetermined positions according to the theme originally selected by the user. The image holder elements 312, in an embodiment, appear as outlines of borders for images to be placed into the electronic scrapbook. The outlines as shown are rectangles, although they may be other shapes, such as ovals, circles, triangles, other polygons, and generally any shape. A user may cause an image to be displayed in an image holder element 312 by performing a drag-and-drop operation from a picture bar to the image holder element 312. The image may then appear cropped according to the boundary of the shape. In an embodiment, once an image has been moved to an image holder element 312, the image may be further manipulated relative to the image holder element 312. For example, if an image does not fit within the image holder element 312, the user may drag the image to change which part of the image is displayed within the boundary of the image holder element 312. The user may also perform zoom operations and, generally, may be provided with the ability to perform other operations for controlling display of images in the electronic scrapbook.

In an embodiment, the interface also includes various text holder elements 314, which may be provided to the user in predetermined positions according to a theme selected by the user. A user may select a text holder element and input text to be displayed as part of the electronic scrapbook at a corresponding location. The text may relate, for example, to images on the same page as the text. As with other elements of the electronic scrapbook, a user designing the electronic scrapbook may have the ability to change the appearance of the text, such as by changing the font, font size, color, and in other ways.

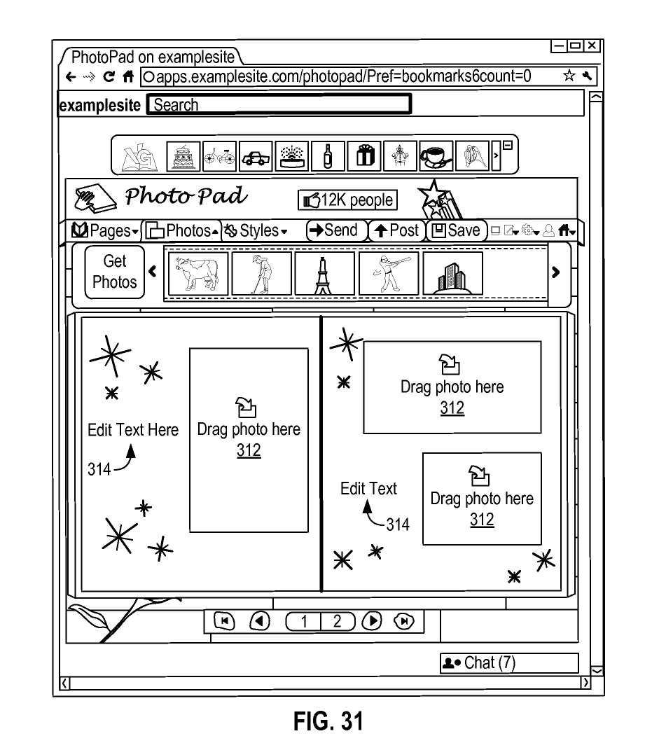

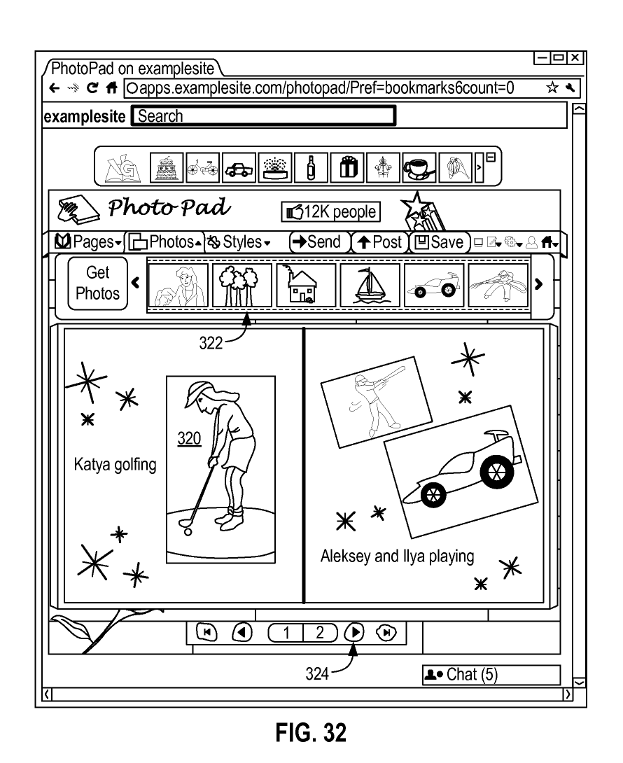

FIG. 32 shows an illustrative example of a screenshot of the interface as it may appear upon manipulation of the page shown in FIG. 31. For example, an image 320 may appear as superimposed on an area of the display where a corresponding image holder element was located. A user may, for example, have performed a drag and drop operation from a picture bar 322 (which may correspond to the picture bar 304, described above) onto the image holder element. A similar operation may have been performed by the user for other images of the picture bar 322 and other image holder elements, thereby causing other images to appear on the display.

In addition, as shown in FIG. 32, user-supplied text may appear in place of various text holder elements. For example, the text “Katya golfing” appears in place of one of the text holder elements 314 illustrated in FIG. 31. The user may have selected the text holder element with an input device and provided the text for the element. As shown, text for other text holder elements also appears in place of the text holder elements due to similar actions taken by the user.

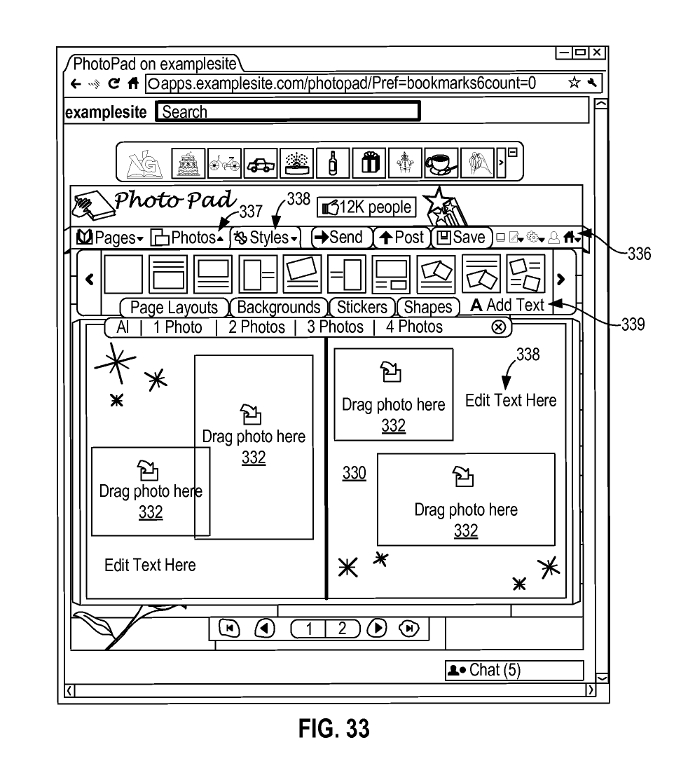

As noted, various embodiments of the present disclosure provide useful predetermined designs to enable users to design electronic scrapbooks. However, embodiments of the present disclosure also provide flexibility to enable users to customize predetermined designed. FIG. 33, for example, provides an illustrative example of a screenshot of the interface as it may appear to a user that has selected a page navigation element 324 shown in FIG. 32. In FIG. 33, a blank page 330 appears, having image holder elements 332 and text holder elements 334, such as described above.

Also shown in FIG. 33 (and other figures) is a function bar 336 that includes a plurality of interface elements that enable users to take various actions in connection with an electronic scrapbook. For instance, in FIG. 32, a photo element 337 was selected, allowing the user the ability to select from various images available for insertion into the electronic scrapbook. In FIG. 33, a styles element 338 has been selected. Selection of the styles element, in this illustrated embodiment, causes a style bar 339 to appear. The style bar, in an embodiment, includes a plurality of interface elements that allow a user to select from a plurality of templates for a currently displayed page of the electronic scrapbook. As shown, the interface elements appear as images configured to approximate the layout of images, text, and/or other features of the page. Upon selection by a user of the interface elements in the style bar 339, the page will appear with a corresponding layout of features for the electronic scrapbook. As shown in FIG. 33, the layout may include a predetermined arrangement of elements (such as image holder elements and text holder elements) that may be manipulated or otherwise arranged by the user.

FIG. 33 (and other figures) also show additional interface elements that add flexibility to users in designing electronic scrapbooks. Users may select various interface elements to be provided with various other features to include in an electronic scrapbook, such as stickers (images other than user-provided images), shapes, and other content for inclusion.

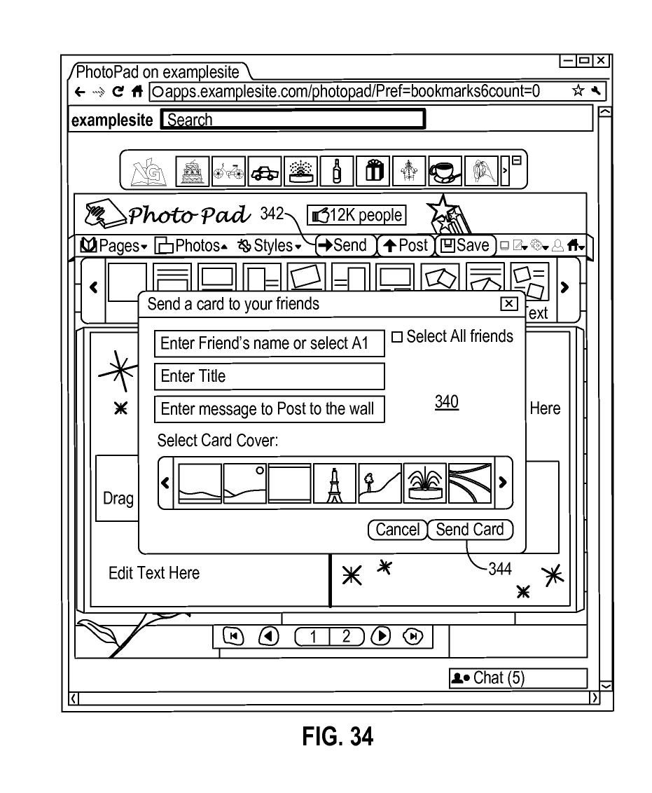

FIG. 34 also shows functionality that may be available to users. In particular, FIG. 34 shows an illustrative example of a screenshot of the interface in a state that allows users to communicate information regarding an electronic scrapbook. In this particular example, a pop-up box 340 appears superimposed on an electronic scrapbook. The pop-up box 340 may have appeared subsequent to selection of a send button 342, which is shown in other figures. The user may, for example, select the send button 342 upon completion of an electronic scrapbook or at any other state in the electronic scrapbook's creation.

In an embodiment, the pop-up box 340, as shown in the figure, allows users to specify one or more recipients to virtually receive a communication (such as a gesture or other type of communication) providing access to the created electronic scrapbook. The recipients may be, for example, users of a social network that are directly or otherwise connected to the user that is completing the fields in the pop-up box 340. As shown, the pop-up box includes other fields, such as a title field that allows the user to specify a title for the communication and a message field that allows the user to specify a message to be communicated to the specified recipients. In addition, one or more images may be provided for the user to allow the user to select an image to be included with the communication.

As shown in FIG. 34, the pop-up box 340 includes a send button 344 that the user may select upon completion of one or more of the fields of the pop-up box 340. Selection of the send button 344 may cause one or more actions to be taken. In an embodiment, a message is posted on a wall social networking feature of users specified in the pop-up box 344. The message may include one or more elements (which may include a hyperlink or other tool) that may be selected by the recipients to view the contents of the electronic scrapbook. As another example, an electronic message may be sent to the specified recipients. The electronic message may be an electronic mail message, an instant electronic message, or other type of message and may include a selectable element for accessing the electronic scrapbook. Generally, any method of notifying specified users of the electronic scrapbook and providing access may be used.

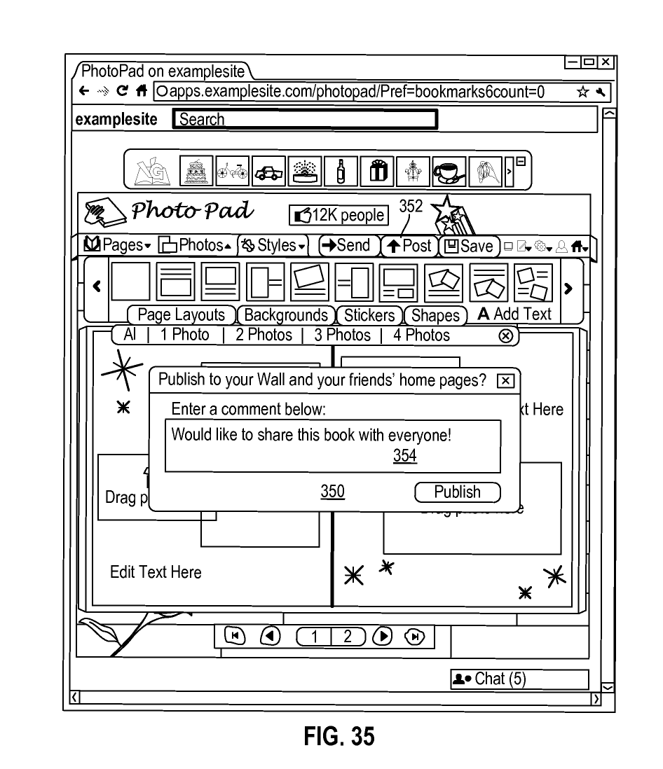

FIG. 35 shows an illustrative example of a screenshot of the interface in a state that allows users to communicate the availability of the electronic scrapbook to other users in a manner different from that illustrated in FIG. 34. In particular, FIG. 35 shows a pop-up box 350 superimposed on the interface. The pop-up box 350 may appear subsequent to user selection of a post button 352 of the interface (also shown in other figures). In this example, the user may use the pop-up box to cause a message to appear on a wall feature of the user's account with a social network whose resources are used to provide access to the electronic scrapbook. The message may include content specified by the user in a text field 354 of the pop-up box 350.

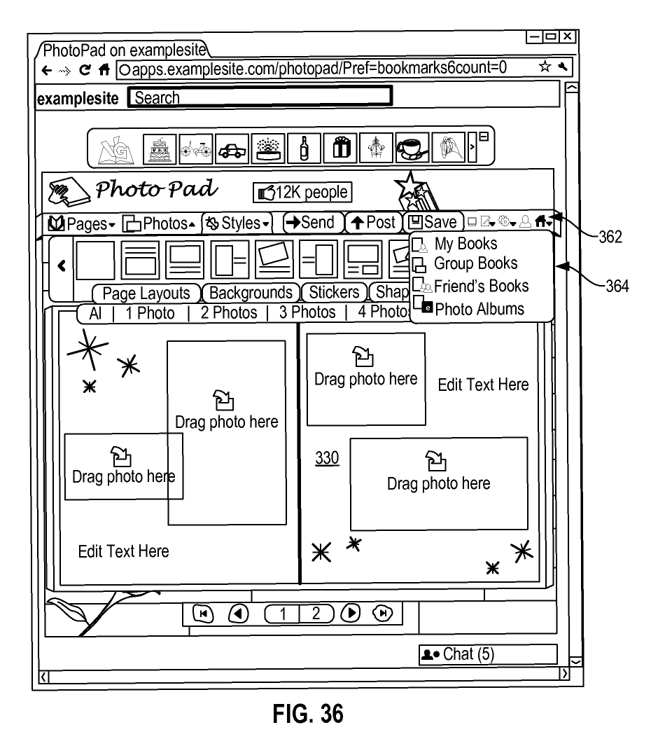

Other features in accordance with embodiments of the present disclosure may be accessible in a manner illustrated by FIG. 36, which shows an illustrative example of a screenshot of the interface that is similar to the screenshot shown in FIG. 33. In FIG. 36, however, the user has selected a home button 362, thereby causing a drop-down menu 364 to appear below. The drop-down menu 364, in an embodiment, includes various options for viewing electronic scrapbooks. For example, an option labeled “My Books” allows the user to navigate to a page that allows access to electronic scrapbooks that the user himself or herself has created. The page may resemble the display shown in FIG. 29, with representations of electronic scrapbooks arranged on a virtual bookshelf. An option labeled “Group Books” allows the user to navigate to a page that allows access to electronic scrapbooks that the user has created in collaboration with one or more other users. An option labeled “Friend's Books” allows the user to navigate to a page that allows access to electronic scrapbooks that other users have created and to which the other users have granted access (or that are publicly viewable). Another may allow the user to navigate to a page that allows access to electronic scrapbooks that are created automatically using collections of images (or other content) that the user has collected using other tools, such as image organization tools of a social network provider. Other options may also be included.

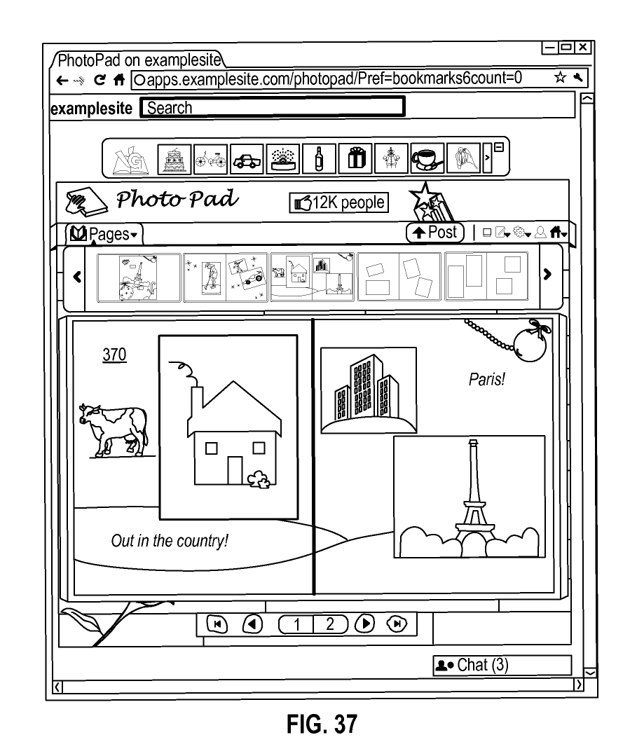

FIG. 37 shows an illustrative example of the interface in a state that provides for viewing (but not necessarily editing) of an electronic scrapbook. A user may navigate to a page that resembles the display in FIG. 37 upon selection of a hyperlink or other tool for accessing the electronic scrapbook. As shown, the display in FIG. 37 shows an interior page of an electronic scrapbook as the page has been designed. Interface controls for manipulating the display and arrangement of various elements of the electronic scrapbook are not visible. In an embodiment, a page navigation bar 372 is included. The page navigation bar 372, in this example, includes representations of the various pages of the electronic scrapbook that the user may select to navigate to corresponding pages of the electronic scrapbook. The representations may resemble corresponding pages. For instance, the representations may be thumbnail images of the corresponding pages.

FIG. 38 shows an illustrative example of a process for providing access to an electronic scrapbook, such as an electronic scrapbook created in accordance with the above description. In an embodiment, the process illustrated in FIG. 38 includes receiving 382 viewing and/or editing permission specifications for the electronic scrapbook. The specifications may be received as part of or otherwise in connection with a request to create an electronic scrapbook, although the specifications may be received at other times, such as at a time after creation of an electronic scrapbook. The specifications, in an embodiment, identify a set of users who are able to view and/or edit the electronic scrapbook. The identified set of users may be users of a social network that have a particular property, such as users that are directly linked to the creator of the electronic scrapbook by a social network. The users may be otherwise specified, such as by electronic mail addresses or other identifiers that are not necessarily utilized by a social network. The set of users may be a definite set, such as a set of particular users specified by the scrapbook creator, or may be indefinite, such as a set of users that may change over time. For example, the permission specifications may specify that the scrapbook is viewable and/or editable by the general public. In addition, the permission specifications may specify one set of users that is able to view the electronic scrapbook and another set of users that is able to edit the electronic scrapbook. The set of users that are able to view the electronic scrapbook and the set of users that are able to edit the electronic scrapbook may be the same set, may be different sets, may have a non-empty intersection, or may be disjoint. Further, the permissions may specify one or more other actions that may or may not be taken, such as commenting on the electronic scrapbook.

In an embodiment, once the permission specifications are received, the permission specifications are applied 384 to the corresponding electronic scrapbook. One or more records associated with the electronic scrapbook in a data store, for instance, may be updated according to the received permission specifications. In this manner, when requests to view and/or edit the electronic scrapbook are received, the applied permission specifications may be used to determine whether to provide requested access to the electronic scrapbook.

Accordingly, in an embodiment, access to the electronic scrapbook is provided 386 according to the applied permission specifications. As an illustrative example, a “friend” of a user that created the electronic scrapbook may select a hyperlink to access the electronic scrapbook. If the permission specifications indicate that the friend can access the electronic scrapbook, access may be provided to the friend. If the permission specifications indicate that the friend is unable to edit the electronic scrapbook but that the friend may view the electronic scrapbook, then access may be limited to viewing the electronic scrapbook. Similarly, if the permission specifications indicate that the friend is able to edit the electronic scrapbook, providing the friend access to the electronic scrapbook may include enabling the friend to modify the electronic scrapbook, such as by providing an interface similar to the interface described above.

FIG. 39 provides an illustrative example of a process for providing access to an electronic scrapbook, in accordance with an embodiment. In this example, the process illustrated in FIG. 39 includes receiving 392 a request to access the electronic scrapbook. The request may have been generated subsequent to selection of a hyperlink to the electronic scrapbook or, generally, in any suitable manner. The request to access the electronic scrapbook may indicate a type of access requested, such as viewing access or editing access, as described above.

Upon receipt of the request to access the electronic scrapbook, in an embodiment, permissions for the electronic scrapbook are accessed 394. One or more records in a data store that store information indicating the permissions, for example, may be accessed. In an embodiment, a determination is made 396, based at least in part on the accessed permissions, whether to provide access to the electronic scrapbook. If a determination is made that the requested access is not allowed then, in an embodiment, the requested access is denied 398. An error message telling a user that requested the access that access is denied may be sent to the user, for example, If, however, a determination is made that the requested access is allowed, then, in an embodiment, the requested access is provided 399. The user may be allowed, for example, to navigate to an interface that allows the requested access.

As noted, various embodiments of the present disclosure provide for the ability to automatically generate electronic scrapbooks for users. Viewing (or otherwise consuming) content, such as photographs and other images, in an electronic scrapbook, for instance, may be desirable as it provides a more fulfilling user experience. Accordingly, FIG. 40 illustrates a flowchart for an illustrative example of a process for automatically generating an electronic scrapbook, in accordance with an embodiment. In this example, the process includes receiving 402 a request for an automatically generated scrapbook. An interface element, such as described above, may have been selected by a user, for example. In another embodiment, the request may be generated at other times and independent of a specific user instruction to automatically generate an electronic scrapbook.

In an embodiment, one or more content sources for the electronic scrapbook are identified 404. The content sources may be any collections of content that may be used for an electronic scrapbook. In an embodiment, the content sources each corresponds to electronic folders of content that are used to organize the content. The folders may be, for example, folders used to organize images uploaded to a social network account. Generally, however, the content sources may be content sources, such as sources of content stored locally by the user and/or sources maintained by other users.

In an embodiment, content is selected 406 from the identified content sources. Selecting the content may be performed in various ways. For example, all of the content of all of the identified content sources may be selected. As another example, a user may be provided to select content from the content sources. The user may, for example, identify photographs in an electronic folder that he or she wishes to include in an electronic scrapbook. Generally, any manner of selecting content from the identified content sources may be used.

With content selected, in an embodiment, an electronic scrapbook is generated 408 using all or some of the selected content. Generating the electronic scrapbook may be accomplished in various ways. For instance, a style for the electronic scrapbook may be identified (which may be a randomly selected and/or default style) and a number of pages may be generated for the electronic scrapbook depending on the amount of content to be included in the electronic scrapbook. In one embodiment, each page of the electronic scrapbook (which may have the appearance of two side-by-side pages of a physical book) corresponds to two images (one for each side of the page), although other configurations are possible. For instance, each page may use more complicated layouts, such as those shown in the figures. Generally, the electronic scrapbook may be generated in any suitable manner.

When the electronic scrapbook is generated, access to the electronic scrapbook may be provided to one or more users. A user corresponding to a social network account from which the content was selected, for example, may be provided the ability to view and/or modify the generated electronic scrapbook. Similarly, other users, such as users having social network accounts linked to an owner of the generated scrapbook, may be allowed to view and/or edit the generated electronic scrapbook. Generally, any set of users may be provided access, such as in a manner described above.

FIG. 41 is a simplified block diagram of a computer system 4100 that may be used to practice an embodiment of the present invention. In various embodiments, computer system 4100 may be used to implement any of the systems illustrated and described above. For example, computer system 4100 may be used to implement any of the processes described herein, and combinations and/or variations thereof. The computer system 4100 may also be used to provide an interface, such as the interfaces shown in the Figures or similar such interfaces. The computer system 4100 may be a component of a network of similar computer systems that are collectively operable to perform methods and otherwise implement various embodiments of the present disclosure.

As shown in FIG. 41, computer system 4100 includes a processor 4102 that communicates with a number of peripheral subsystems via a bus subsystem 4104. These peripheral subsystems may include a storage subsystem 4106, comprising a memory subsystem 4108 and a file storage subsystem 4110, user interface input devices 4112, user interface output devices 4114, and a network interface subsystem 4116.

Bus subsystem 4104 provides a mechanism for enabling the various components and subsystems of computer system 4100 to communicate with each other as intended. Although bus subsystem 4104 is shown schematically as a single bus, alternative embodiments of the bus subsystem may utilize multiple busses.

Network interface subsystem 4116 provides an interface to other computer systems and networks. Network interface subsystem 4116 serves as an interface for receiving data from and transmitting data to other systems from computer system 4100. For example, network interface subsystem 4116 may enable a user computer to connect to the Internet and facilitate communications using the Internet.

User interface input devices 4112 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 4100.

User interface output devices 4114 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 4100. An advertisement may be output by computer system 4100 using one or more of user interface output devices 4114.

Storage subsystem 4106 provides a computer-readable storage medium for storing the basic programming and data constructs that provide the functionality of the present invention. Software (programs, code modules, instructions) that, when executed by a processor provide the functionality of the present invention may be stored in storage subsystem 4106. These software modules or instructions may be executed by processor(s) 4102. Storage subsystem 4106 may also provide a repository for storing data used in accordance with the present invention. Storage subsystem 4106 may comprise memory subsystem 4108 and file/disk storage subsystem 4110.

Memory subsystem 4108 may include a number of memories including a main random access memory (RAM) 4118 for storage of instructions and data during program execution and a read only memory (ROM) 4120 in which fixed instructions are stored. File storage subsystem 4110 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 4100 can be of various types including a personal computer, a portable computer, a workstation, a network computer, a mainframe, a kiosk, a server or any other data processing system. Due to the ever-changing nature of computers and networks, the description of computer system 4100 depicted in FIG. 41 is intended only as a specific example for purposes of illustrating the preferred embodiment of the computer system. Many other configurations having more or fewer components than the system depicted in FIG. 41 are possible.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention.

While the invention has been particularly shown and described with reference to a specific embodiment thereof, it will be understood by those skilled in the art that the foregoing and other changes in the form and details may be made therein without departing from the spirit or scope of the invention. These and other equivalents and alternatives are intended to be included within the scope of the present invention. Therefore, the scope of this invention should not be limited to the embodiments described above, and should instead be defined by the following claims.

What is claimed is:

1. A computer-implemented method for receiving and organizing electronic greetings from users linked by an electronic social network, the method comprising:
under the control of one or more computer systems configured with executable instructions,
receiving an electronic greeting from a user, wherein the electronic greeting is sent from the user using one or more resources of the electronic social network;
incrementing a number of electronic greetings received from the user;
providing an entry of the received electronic greeting in an electronic representation of a book of received electronic greetings; and
in the event that the received electronic greeting is part of a predetermined collection of received electronic greetings, providing a representation of the received electronic greeting in a depiction of the collection and incrementing a number of incentive points associated with the collection.

2. The computer-implemented method of claim 1, wherein the electronic representation of the book of received electronic greetings corresponds to a particular user of the electronic social network.

3. The computer-implemented method of claim 1, wherein the electronic greeting is sent to a receiver associated with the electronic representation of a book of received electronic greetings, wherein the user is a member of a set of users that have sent one or more electronic greetings to the receiver, and wherein the method further comprises tracking a number of electronic greetings sent by each member of the set to the receiver.

4. The computer-implemented method of claim 3, further comprising providing for display an ordering of the members of the set according to the tracked number of electronic greetings sent to the receiver.

5. The computer-implemented method of claim 1, further comprising making the electronic representation of the book of received electronic greetings accessible to one or more users of the electronic social network through an interface of the electronic social network.

6. The computer-implemented method of claim 1, wherein the electronic greeting corresponds to an image that resembles a physical greeting card.

7. The computer-implemented method of claim 1, wherein the predetermined collection of received electronic greetings corresponds to a particular user of the electronic social network.

8. A computer-readable storage medium, having stored thereon instructions that, when executed by one or more processors, cause the one or more processors to at least:
receive an electronic greeting from a user, wherein the electronic greeting is sent from the user using one or more resources of the electronic social network;
increment a number of electronic greeting received from the user;
provide an entry of the received electronic greeting in an electronic representation of a book of received electronic greetings; and
in the event that the received electronic greeting is part of a predetermined collection of received electronic greetings, provide a representation of the received electronic greeting in a depiction of the collection and incrementing a number of incentive points associated with the collection.

9. The computer-readable storage medium of claim 8, wherein the electronic representation of the book of received electronic greetings corresponds to a particular user of the electronic social network.

10. The computer-readable storage medium of claim 8, wherein the electronic greeting is sent to a receiver associated with the electronic representation of a book of received electronic greetings, wherein the user is a member of a set of users that have sent one or more electronic greetings to the receiver, and wherein the method further comprises tracking a number of electronic greetings sent by each member of the set to the receiver.

11. The computer-readable storage medium of claim 8, wherein the predetermined collection of received electronic greetings corresponds to a particular user of the electronic social network.

12. A computer system for receiving and organizing electronic greetings from users linked by an electronic social network, comprising:
one or more processors;
memory accessible by the one or more processors, the memory including executable instructions that, when executed by the one or more processors, cause the one or more processors to collectively at least:
receive an electronic greeting from a user, wherein the electronic greeting is sent from the user using one or more resources of the electronic social network;
increment a number of electronic greetings received from the user;
provide an entry of the received electronic greeting in an electronic representation of a book of received electronic greetings; and
in the event that the received electronic greeting is part of a predetermined collection of received electronic greetings, provide a representation of the received electronic greeting in a depiction of the collection and incrementing a number of incentive points associated with the collection.

13. The computer system of claim 12, wherein the predetermined collection of received electronic greetings corresponds to a particular user of the electronic social network.

14. The computer system of claim 12, wherein the electronic representation of the book of received electronic greetings corresponds to a particular user of the electronic social network.

15. A computer-implemented method of managing content, comprising: under the control of one or more computer systems configured with executable instructions,
receiving one or more instances of content from a user for an electronic scrapbook, the electronic scrapbook including a plurality of pages;
receiving input from the user for arranging the one or more instances of content among the pages of the electronic scrapbook; and
providing for display the electronic scrapbook to one or more other users such that the each of the one or more users is able to navigate among the pages of the electronic scrapbook.

16. The computer-implemented method of claim 15, further comprising providing a scrapbook interface to the user, the scrapbook interface including the pages and enabling the user to navigate among the pages and arrange the one or more instances of content among the pages.

17. The computer-implemented method of claim 15, wherein providing for display the electronic scrapbook to the one or more other users includes providing an interface to at least one other user that enables the at least one other user to modify the electronic scrapbook.

18. The computer-implemented method of claim 15, wherein the one or more computer systems are resources of a social network provider and wherein the user is a member of a social network maintained by the social network provider.

19. The computer-implemented method of claim 15, further comprising selecting the one or more other users according to a relationship of the one or more other users to the user in a social network.

20. The computer-implemented method of claim 15, further comprising providing one or more predetermined layouts to the user and wherein at least some of the input corresponds to user manipulation of the one or more predetermined layouts.

21. The computer-implemented method of claim 15, wherein providing for display the electronic scrapbook includes providing a visual representation of a bookshelf, the visual representation of the bookshelf including a selectable visual representation of the electronic scrapbook.
